(19) United States
(12) Patent Application Publication
(10) Pub. No.: US 2005/0001014 A1
(43) Pub. Date: Jan. 6, 2005

(54) Method of mounting electronic part and flux-fill

(75) Inventors: Shuichi Takeuchi, Kawasaki (JP); Hidehiko Kira, Kawasaki (JP); Kenji Kobae, Kawasaki (JP); Norio Kainuma, Kawasaki (JP); Hiroshi Kobayashi, Kawasaki (JP); Takayoshi Matsumura, Kawasaki (JP); Shigeo Matsunuma, Kawasaki (JP); Tomohisa Yagi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 10/816,915

(22) Filed: Apr. 5, 2004

(30) Foreign Application Priority Data
Jul. 4, 2003 (JP) 2003-192275

(51) Int. Cl. B23K 20/10; B23K 31/02

(52) U.S. Cl. 228/110.1; 228/207; 228/223

(57) ABSTRACT

The method of mounting an electronic part is capable of securely mounting the electronic part having fine solder bumps without excessively heating the part. The method of comprises the steps of: applying flux-fill, which acts as flux and under-filling resin, on a surface of a mount board, in which electrodes are formed; respectively connecting solder bums of the electronic part with the electrodes; and simultaneously filling a gap between the electronic part and the mount board with the flux-fill, wherein the solder bumps are made contact with the electrodes, and ultrasonic vibration energy is applied to contact portions of the solder bumps and the electrodes in the connecting step.

### BACKGROUND OF THE INVENTION

The present invention relates to a method of mounting an electronic part having solder bumps and flux-fill for the method.

A conventional method of mounting a semiconductor part having solder bumps onto a mount board by flip-chip connection will be explained with reference to FIGS. 4A-4F.

FIG. 4A shows a mount board 12 onto which a semiconductor chip (an electronic part) 10 will be mounted. Electrodes 14 (one of them is shown) are formed on a surface of the mount board 12, and solder resist 16 covers the surface of the mount board 12. In FIG. 4B, flux 18 is spouted out from a nozzle 17 so as to cover surfaces of the electrodes 14. In FIG. 4C, solder bums 20 (one of them is shown) of the semiconductor chip 10 are corresponded to the electrodes 14 so as to temporarily fix the semiconductor chip 10 on the mount board 12 by viscosity of the flux 18.

In FIG. 4D, the semiconductor chip 10, which has been temporarily fixed, is connected to the mount board 12 by solder-reflow. Oxide films are removed from the electrodes 14, by activation of the flux 18, during the solder-reflow, so that the solder bumps 20 can be welded to the electrodes 14. In FIG. 4E, the flux 18 left around the electrodes 14 has been removed by cleaning. The flux 18 includes components corroding the electrodes 14. Therefore, the flux 18 left on the mount board 12 must be removed. In FIG. 4F, under-filling resin 22 fills gaps between the semiconductor chip 10 and the mount board 12, so that the semiconductor chip 10 can be completely mounted on the mount board 12.

Another conventional method of mounting a semiconductor part having solder bumps onto a mount board by flip-chip connection will be explained with reference to FIGS. 5A-5C.

In this method, flux-fill 24, which acts as flux and under-filling resin, is applied to and around electrodes 14 of a mount board 12 instead of the flux. Its thickness is relatively thick (see FIG. 5A). Solder bums 20 (one of them is shown) of a semiconductor chip 10 are corresponded to the electrodes 14, to which the flux-fill 24 has been applied, so as to temporarily fix the semiconductor chip 10 on the mount board 12 (see FIG. 5B). Then, the semiconductor chip 10 is connected to the mount board 12 by solder-reflow, and the flux-fill 24 is solidified, so that the semiconductor chip 10 can be completely mounted on the mount board 12 (see FIG. 5C).

In the conventional method shown in FIGS. 4A-4F, the flux 18 is used to remove the oxide films from the electrodes 14, etc., so the cleaning step for removing the flux 18 is necessary. These days, the fine solder bums 20 are formed in the high density semiconductor chip 10, so that the gaps between the semiconductor chip 10 and the mount board 12, which will be filled with the under-filling resin 22, must be smaller and smaller. Therefore, it is difficult to fill the gaps, and it takes a long time to fill the gaps with the resin 22.

On the other hand, in the method shown in FIGS. 5A-5C, no flux is used, so the cleaning step can be omitted. Further, the flux-fill 24 acts as the under-filling resin, so the under-filling step too can be omitted.

However, the solder bumps 20 are welded to the electrodes 14 by soldr-reflow, no fillers are included in the resin of the flux-fill 24. If the resin includes fillers, the solder bumps 20 cannot be securely electrically connected to the electrodes 14. Further, if the under-filling resin includes no fillers, reliability of a device must be lower.

In the case of using the flux-fill 24, the flux-fill 24 is solidified when the solder bumps 20 are melted. Therefore, resin which solidify at temperature equal to or lower than the melting point of the solder bumps 20 cannot be employed. These days, lead-free solder is required, so its melting point must be higher. Thus, the flux-fill 24 which solidify at higher temperature is employed. However, devices for sensors are damaged at high temperature, so that the method is not proper for such devices.

### SUMMARY OF THE INVENTION

The present invention has been invented to solve the disadvantages of the conventional methods.

An object of the present invention is to provide a method of mounting an electronic part, which is capable of securely mounting the electronic part having fine solder bumps without excessively heating the part.

Another object of the present invention is to provide flux-fill for the method.

Namely, the method of the present invention comprises the steps of: applying flux-fill, which acts as flux and under-filling resin, on a surface of a mount board, in which electrodes are formed; respectively connecting solder bums of the electronic part with the electrodes; and simultaneously filling a gap between the electronic part and the mount board with the flux-fill, wherein the solder bumps are made contact with the electrodes, and ultrasonic vibration energy is applied to contact portions of the solder bumps and the electrodes in said connecting step. Note that, an enough amount of the flux-fill for fully filling the gap is applied to the mount board.

In the method of the present invention, the ultrasonic vibration energy is applied to the contact portions of the solder bumps and the electrodes so as to connect the contact portions, so that the electronic part is not heated until melting point of the solder bumps. The electronic part can be easily and securely connected with the mount board at low temperature. Since the electronic part is not excessively heated, reliability of the device including the electronic part can be highly improved.

In the method, the electronic part may be ultrasonic-vibrated so as to connect the solder bums with the electrodes in said connecting step. In this case, the ultrasonic vibration energy can be concentrated to the contact portions, so that they can be securely connected.

In the method, the flux-fill may include fillers. By using the flux-filler including the fillers, reliability of a device having the electronic part and the mount board can be improved.

The method may further comprise the step of heating the flux-fill to solidify. In this case, it is effective to select the flux-fill which solidifies at low temperature so as not to damage the electronic part.

The flux-fill for the method of the present invention comprises: a main agent made from resin; a hardening agent for hardening the resin; a hardening accelerator; organic acid acting as flux; and fillers.

### BRIEF DESCRIPTION OF THE DRAWINGS

Embodiments of the present invention will now be described by way of examples and with reference to the accompanying drawings, in which:

FIGS. 1A-1C are explanation views showing an embodiment of the method of the present invention, in each of which one solder bump and one electrode are shown;

FIGS. 2A-2D are explanation views showing the embodiment of the method, in each of which the whole semiconductor chip and the whole mount board are shown;

FIG. 3 is a graph of extension rate of solder with respect to flux;

FIGS. 4A-4F are explanation views showing the conventional method of mounting the electronic part; and

FIGS. 5A-5C are explanation views showing another conventional method of mounting the electronic part.

### DETAILED DESCRIPTION OF THE EMBODIMENTS

Preferred embodiments of the present invention will now be described in detail with reference to the accompanying drawings.

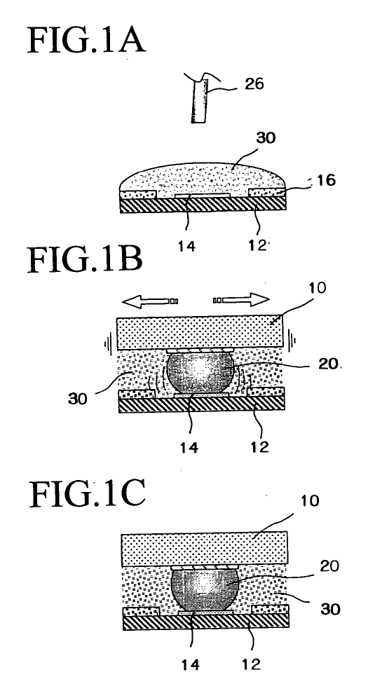

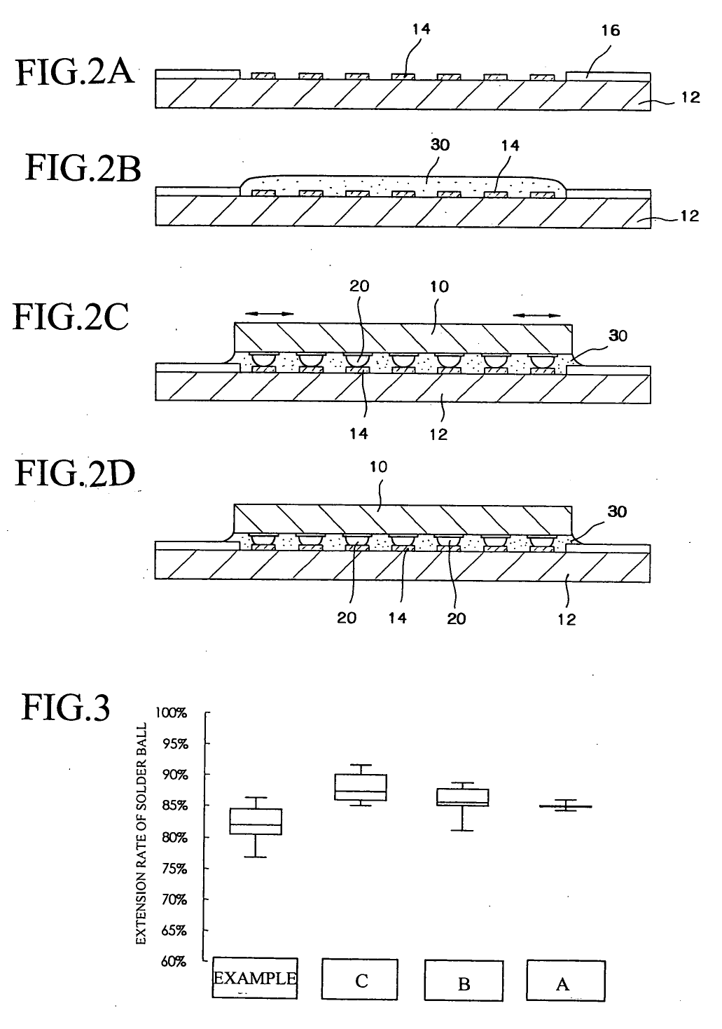

An embodiment of the method of the present invention will be explained with reference to FIGS. 1A-1C and 2A-2D. In FIGS. 2A-2D, a semiconductor chip 10, which is an example of electronic parts, is mounted onto a mount board 12. FIGS. 1A-1C are enlarged views of one solder bump 20 of the semiconductor chip 10 and one electrode 14 of the mount board 12 to be connected each other.

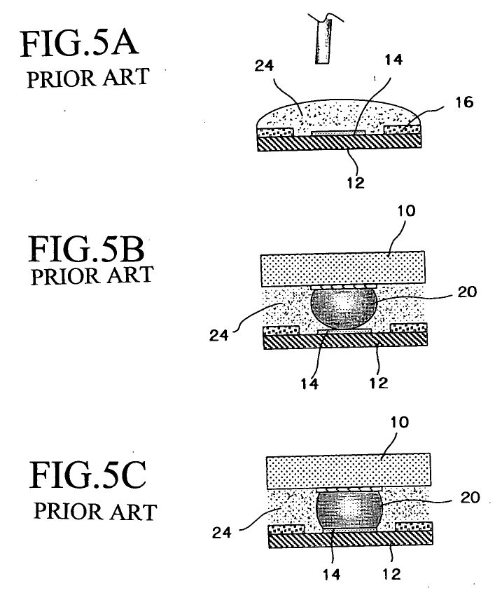

In the present embodiment, the semiconductor chip 10 is mounted onto the mount board 12 with flux-fill 30, which acts as flux and under-filling resin, as well as the conventional method shown in FIGS. 5A-5C. Unlike the conventional method, the flux-fill 30 of the present embodiment includes fillers.

In FIG. 1A, the flux-fill 30 is spouted out from a nozzle 26 onto a surface of the mount board 12, on which the electrodes 14 are formed, and the electrode 14 and its periphery are covered with the flux-fill 30. FIG. 2A shows a sectional view of the mount board 12 having the electrodes 14. In FIG. 2B, the flux-fill 30 has been applied on the surface of the mount board 12.

In the present embodiment, the flux-fill 30 includes fillers, and ultrasonic vibration is applied to the semiconductor chip 10 so as to securely electrically connect the solder bumps 20 with the electrodes 14.

In FIG. 1B, the solder bump 20 is pressed onto the electrode 14 with applying ultrasonic vibration to the semiconductor chip 10 so as to connect the solder bump 20 with the electrode 14. With this manner, the fillers in the flux-fill 30 are pushed away from a surface of the electrode 14 by the solder bump 20, so that the solder bump 20 can be securely electrically connected with the electrode 14 without obstructing electric conduction. Since, the flux-fill 30 acts as flux, oxide films formed on the electrodes 14, etc. can be removed by ultrasonic vibration energy. Therefore, the solder bumps 20 can be connected with the electrodes 14 by the ultrasonic vibration energy only.

In FIG. 1C, the solder bump 20 is completely connected with the electrode 14, so that the semiconductor chip 10 is mounted on the mount board 12.

In FIG. 2C, the semiconductor chip 10 is correctly located with respect to the mount board 12, the solder bumps 20 are pressed onto the electrodes 14, and the ultrasonic vibration is applied to the semiconductor chip 10 so as to connect the solder bumps 20 with the electrodes 14.

In FIG. 2D, the semiconductor chip 10 is completely mounted on the mount board 12. The solder bumps 20 have been respectively connected with the electrodes 14, and gaps between the semiconductor chip 10 and the mount board 12 are completely filled with the flux-fill 30.

In the present embodiment, the semiconductor chip 10 is mounted onto the mount board 12 without heating and melting the solder bumps 20. Therefore, even if a melting point of the solder bumps 20 is high, the solder bumps 20 can be connected without heating to the high melting point.

After the solder bumps 20 are connected with the electrodes 14 by the ultrasonic vibration, the flux-fill 30, which has filled the gaps, is solidified. If resin included in the flux-fill 30 can be solidified at low temperature, the semiconductor chip 10 can be mounted without excessively heating the semiconductor chip 10. Electronic parts, which are easily damaged by heat, can be easily mounted.

In the method of the present embodiment, a step of under-filling the gaps between the semiconductor chip 10 and the mount board 12 can be omitted, so that manufacturing efficiency of electronic devices can be improved. Since the under-filling step is omitted, electronic parts, in which fine solder bumps are formed with high density, can be easily mounted.

Further, the resin including fillers can be used for the flux-filler 30, so that reliability of electronic devices, in each of which the electronic part or parts are mounted on the mount board by the method of the present embodiment, can be improved.

Note that, the resin of the flux-fill 30 including fillers may be selected on the basis of a material of the solder bumps 20, a material of plating on the electrodes 14, etc.

In the present embodiment, the flux-filler 30 includes: a main agent made from the resin; a hardening agent for hardening the resin; a hardening accelerator; organic acid acting as flux; a coupling agent; and inorganic fillers. Components of the flux-fill 30 of the present embodiment will be explained. A performance of the flux-fill 30 can be optionally adjusted. For example, the flux-fill 30 is solidified by heating at temperature of 150° C. for one hour.

### Main Agent

Alicyclin epoxy resin, Bisphenol F type epoxy resin, Bisphenol A type epoxy resin, Naphthalene epoxy resin, Biphenyl epoxy resin, Novolak epoxy resin, etc. may be solely or combinedly used as the main agent.

### Hardening Agent

Methyl tetra hydro phthalic anhydride, Mmethyl hexahydrophthalic anhydride, Trihexyl tetra hydro Phthalic anhydride, Trihexyl tetra hydro phthalic anhydride, Methyl-3,6-tetrahydor-1,2,3,6-endomethylenephthalic anhydride, Hexahydro phthalic anhydride, Tri alkyl tetra hydro phthalic anhydride, Tetra hydro phthalic anhydride, Methyl cyclohexene dicarboxylic acid anhydrate, Nadic acid anhydrate, etc. may be used as the hardening agent.

### Hardening Accelerator

Imidazol (2-ethyl-4-methylimidazol, 2-phenylimidazol, 2-phenyl-4-methylimidazol, 1-benzil-2-phenylimidazol, 1-benzil-2-methylimidazol, 1-cyanoethyl-2-methylimidazol, 1-cyanoethyl-2-ethyl-4-methylimidazol, 1-methyl-2-ethylimidazol), Organic phosphine (Triphenylphosphine, Trimethalphosphine, Tetra phenyl phosphonium tetra phenylborate, Tri phenyl phosphine tri phenyl borane), 1,8-Diazabicyclo(5.4.0)undec-7-ene, 1,8-Diazabicyclo(5.4.0)undec-7-ene-p-toluenesulfonate salt, 1,8-Diazabicyclo(5.4.0)undec-7-ene-octylate salt, etc. may be used as the accelerator. Note that, an amount of adding the accelerator is 0.1-40 w/t part.

### Organic Acid

Hydride (Succinic anhydride, Benzoic anhydride acetic anhydride, etc.) may be used as the organic acid. Note that, an amount of adding the organic acid is 5-50 w/t part. The organic acid acts as flux.

### Coupling Agent

β-(3,4-Epoxycyclohexyl) Ethyl Tri-methoxysilane, γ-Glycidoxypropyltrimethoxysilane, N-Phenyl-γ-Aminopropyltrimethoxysilane, γ-Mercaptopropyltrimethoxysilane, Hexamethyldisilazane, Silicone coupling agent, etc. may be used as the coupling agent.

### Inorganic Filler

Silica powders, alumina powders, etc. may be used as the inorganic fillers. Note that, an amount of adding the inorganic fillers is 0.1-670 w/t part.

### EXPERIMENTAL EXAMPLE

An experimental example with the flux-fill described above will be explained.

A size of the semiconductor chip was 5 mm×5 mm. The solder bumps were made from Sn-3Ag-0.5Cu, and a diameter of each bump was 80 μm. Number of the bumps was 530. The bumps were area-arranged on a surface of the semiconductor chip.

The mount board was a build-up substrate. The electrodes were made copper and plated with nickel and gold.

The composition of the flux-fill will be explained.

The main agent included Bisphenol F type epoxy resin (EXA-830LVP, manufactured by Dainihon Inkikagaku, 50 w/t part) and Naphthalene epoxy resin (HP-4032D, manufactured by Dainihon Inkikagaku, 50 w/t part).

The hardening agent was Me-THPA (KRM-291-5, manufactured by Asahidenka, 100 w/t part).

The hardening accelerator was Imidazole (1M2EZ, manufactured by Shikoku Kasei, 0.5 w/t part).

The organic acid was Succinic anhydride (manufactured by Wako Seiyaku, 20 w/t part).

The coupling agent was γ-Glycidoxypropyltrimethoxysilane (KBM-403, manufactured by Shinetsu Kagaku, 1 w/t part) and Hexamethyldisilazane (A-166, manufactured by Shinetsu Kagaku, 1 w/t part).

The inorganic fillers were silica powders (SO-E5, manufactured by Adomatekkusu, 334 w/t part).

The flux-fill was applied onto the mount board. The semiconductor chip was held by a horn and correctly located with respect to the mount board. Then, the solder bumps were pressed onto the electrodes of the mount board. Simultaneously, horizontal vibrations were applied.

Note that, during the connection, temperature of a stage for holding the mount board was maintained at 150° C., temperature of a head of an ultrasonic apparatus, which held the semiconductor chip was maintained at 100° C., a number of vibrations were 50 KHz, an amplitude was 4.0 μm, a load was 10 gf/bump, and the ultrasonic vibration was applied for three seconds. Then, the device was heated in a furnace at temperature of 150° C. for one hour. By heating the device, the resin was solidified and the semiconductor device was completed.

The semiconductor device of the present example and conventional semiconductor devices, which were manufactured with conventional flux-fill, were compared. Results of a thermal cycle test is shown in TABLE 1.

TABLE 1

| | | 150° C. 1 h | | | | |
|---|---|---|---|---|---|---|
| | IMMEDIATELY | AFTER | CYCLE OF THERMAL | | | |
| | AFTER | SOLIDIFI- | CYCLE TEST | | | |
| FLUX FILL | MOUNTING | CATION | 25 | 50 | 75 | 100 |
| EXAMPLE | 0/3 | 0/3 | 0/3 | 0/3 | 0/3 | 0/3 |
| A | 0/3 | 0/3 | 0/3 | 0/3 | 3/3 | — |
| B | 0/3 | 0/3 | 3/3 | — | — | — |
| C | 0/3 | 0/3 | 0/3 | 0/3 | 0/3 | 0/3 |

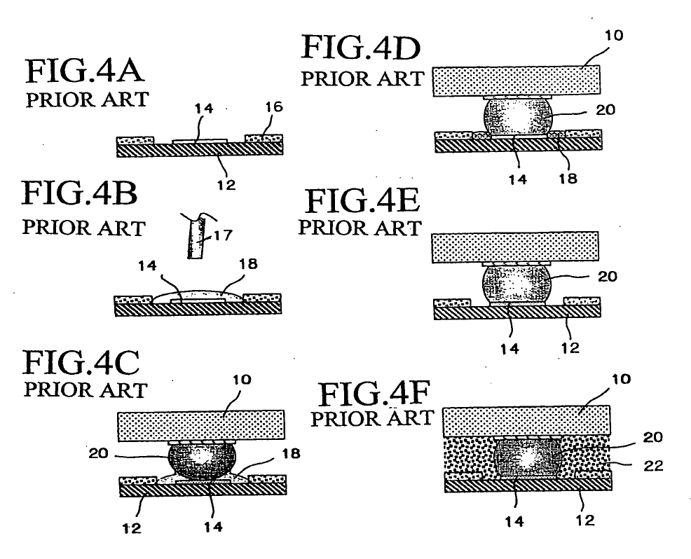

Samples were tested at −65° C., the room temperature and 150° C. for 15 minutes respectively in one cycle of the thermal cycle test. Note that, TABLE 1 shows a rate of producing bad samples, i.e., (number of bad samples)/(number of tested samples). The flux-fill “A” and “B” were conventional flux-fill including no fillers; the flux “C” was used in the conventional method shown in FIGS. 4A-4F.

According to the results, all of the samples manufactured with the flux-fill “A” and “B” were bad. On the other hand, reliability of the samples manufactured with the flux-fill of the example were equal to that of the samples manufactured with the conventional flux “C”. In the samples manufactured with the flux-fill of the example, the solder bumps were connected with the electrodes with prescribed bonding strength. Further, the flux-fill included the fillers, so that the semiconductor chip was connected with the mount board with prescribed strength.

Note that, the flux-fill “B” was not solidified by heating at 150° C. for one hour. Therefore, the samples became bad in an earlier stage.

In the present embodiment, the solder bumps are connected with the electrodes by the ultrasonic vibration. To securely connect the solder bumps with the electrodes, it is important for the flux-fill to act as flux.

Function of flux of the flux-fill “A”, “B” and the example and the flux “C” were compared. The results is shown in FIG. 3. The experiment were performed by the steps of: putting the flux-fill and a solder ball (diameter “D”=0.76 mm) on a copper plate; heating the copper plate to melt the solder ball; and measuring extension rate of the solder ball. Note that, the extension rate (%)=(D−height of melted solder)/D.

The conventional flux-fill “A” and “B” had function of flux. The flux “C” was used in the conventional method shown in FIGS. 4A-4F and originally had high function of flux. According to FIG. 3, the flux-fill of the example had enough activity similar to that the flux “C”. Therefore, oxide films can be removed by the flux-fill when the solder bumps are connected with the electrodes, so that the solder bumps can be securely electrically connected with the electrodes.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

1. A method of mounting an electronic part,
comprising the steps of:
applying flux-fill, which acts as flux and under-filling resin, on a surface of a mount board, in which electrodes are formed;
respectively connecting solder bums of the electronic part with the electrodes; and
simultaneously filling a gap between the electronic part and the mount board with the flux-fill,
wherein the solder bumps are made contact with the electrodes, and ultrasonic vibration energy is applied to contact portions of the solder bumps and the electrodes in said connecting step.

2. The method according to claim 1,
wherein the electronic part is ultrasonic-vibrated so as to connect the solder bums with the electrodes in said connecting step.

3. The method according to claim 1,
wherein the flux-fill includes fillers.

4. The method according to claim 1,
further comprising the step of heating the flux-fill to solidify.

5. The method according to claim 1,
wherein the flux-fill comprises:
a main agent made from resin;
a hardening agent for hardening the resin;
a hardening accelerator;
organic acid acting as flux; and
fillers.

6. A flux-fill, comprising:
a main agent made from resin;
a hardening agent for hardening the resin;
a hardening accelerator;
organic acid acting as flux; and
fillers.
